(19) United States
(12) Patent Application Publication
(10) Pub. No.: US 2024/0066914 A1
(43) Pub. Date: Feb. 29, 2024

(54) WHEEL PLATE ASSEMBLY AND METHOD FOR PRODUCING WHEEL PLATE INCLUDING COMPOSITE MATERIAL

(71) Applicant: Kuan-Ti HUANG, Kaohsiung (TW)

(72) Inventor: Kuan-Ti HUANG, Kaohsiung (TW)

(21) Appl. No.: 18/089,659

(22) Filed: Dec. 28, 2022

(30) Foreign Application Priority Data
Aug. 31, 2022 (TW) 111132963

(51) Int. Cl. B60B 1/04; B60B 1/02; B60B 5/02

(52) U.S. Cl. CPC B60B 1/042; B60B 1/0253; B60B 5/02; B60B 2310/204; B60B 2310/316

(57) ABSTRACT

A wheel plate assembly is used to solve the time-consuming problem in the conventional process for bonding a composite material to spokes of a wheel plate. The wheel plate assembly comprises a spoke portion, a connecting member, and a wheel plate body. The spoke portion is a thin shell member and defines an inner space therein. The connecting member is protrusively disposed on an outer side of the spoke portion. The wheel plate body includes a receiving space and at least one passage space intercommunicating with the receiving space. The receiving space and the at least one passage space together extend through the wheel plate body. The at least one passage space intercommunicates with the inner space.

### CROSS REFERENCE TO RELATED APPLICATION

The application claims the benefit of Taiwan application serial No. 111132963, filed on Aug. 31, 2022, and the entire contents of which are incorporated herein by reference.

### BACKGROUND OF THE INVENTION

### 1. Field of the Invention

The present invention relates to a wheel plate and, more particularly, to a wheel plate assembly to which a composite material can be easily bonded and a method for producing the wheel plate assembly.

### 2. Description of the Related Art

In a bonding process of a conventional method for bonding a composite material to spokes of a wheel plate, the composite material is firstly adhered to an inner surface of a low-temperature mold. Then, spokes made of foam material are placed in the mold. Next, the spokes made of the foam material are pressed by the mold, and the temperature of the mold is increased, thereby bonding the composite material to the surfaces of the spokes. However, since the temperature of the mold is increased during the process, the subsequent bonding procedure needs to wait until the temperature of the mold is lowered, so as to avoid a premature change (caused by the high temperature of the mold) in the material properties of the composite material adhered to the inner surface of the mold before the mold performs press-bonding on the spokes, thereby avoiding difficult bonding to the spokes. Furthermore, in the case of manual bonding of the composite material, the worker may also be injured by the high temperature of the mold before the mold is cooled. Namely, in the conventional method, the continuous repeated operating process of bonding the composite material to the spokes needs to wait until the mold is cooled, such that the operating time cannot be shortened, and the operation is time-consuming and inconvenient.

Thus, improvement to the conventional method for producing a wheel plate with a composite material is required.

### SUMMARY OF THE INVENTION

To solve the above problem, an objective of the present invention is to provide a wheel plate assembly which can reduce the labor cost and the time cost.

Another objective of the present invention is to provide a wheel plate assembly which can enhance the stability of bonding of the composite material to the wheel plate assembly.

A further objective of the present invention is to provide a method for producing a wheel plate assembly with a composite material, which method can improve the production efficiency and quality.

As used herein, the term “one”, “a” or “an” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

The term “connection”, “engagement”, “coupling”, “assembly”, “installation”, “disposition”, or similar terms referred to herein mainly includes separation of connected members without destroying the members after connection or inseparable connection of the members after connection. A person having ordinary skill in the art would be able to select according to desired demands in the material or assembly of the members to be connected.

A wheel plate assembly according to the present invention comprises a spoke portion, a connecting member, and a wheel plate body. The spoke portion is a thin shell member and defines an inner space therein. The connecting member is protrusively disposed on an outer side of the spoke portion. The wheel plate body includes a receiving space and at least one passage space intercommunicating with the receiving space. The receiving space and the at least one passage space together extend through the wheel plate body. The at least one passage space intercommunicates with the inner space.

A method is provided for producing a wheel plate assembly including a composite material, wherein an air nozzle unit and at last one air bag are disposed in the wheel plate assembly. The method comprises the following steps: coating the spoke portion of the wheel plate assembly with the composite material; placing the wheel plate assembly coated by the composite material into a mold, wherein the mold includes a gas input portion, an upper mold, and a lower mold, and wherein the upper mold and the lower mold have press-bonding contours corresponding to a shape of the wheel plate assembly coated by the composite material; and using the mold to press-bond the composite material onto the wheel plate assembly, and during the press-bonding process, the gas input portion is connected to the gas inlet, wherein a gas is inputted via the gas input portion into the gas inlet to expand the air bag, and wherein expansion of the air bag generates an outward pushing force from an interior of the spoke portion, thereby stably press-bonding the composite material to the wheel plate assembly.

Thus, in the wheel plate assembly according to the present invention, by the structure formed of the spoke portion and the wheel plate body which define the inner space, the receiving space, the passage space which intercommunicate with each other, the composite material can be advantageously pre-adhered to the wheel plate assembly, which benefits the process of press-bonding the composite material to the wheel plate assembly. Furthermore, by application of the nozzle unit and the air bag, during the process of press-bonding the composite material to the wheel plate assembly, a supporting/pushing force can be provided from the interior of the air bag to reinforce the pressure-bearing capacity of the whole wheel plate assembly while enhancing the efficiency and quality of press-bonding of the composite material. Furthermore, by providing the wheel plate body with the mounting hole for insertion of the composite material, the stability of bonding the composite material to the wheel plate assembly can be enhanced. Furthermore, by the overall structure and mechanism of the wheel plate assembly, the mold can maintain the relative high temperature required for press-bonding, such that it is not necessary to repeat the operation of increasing the temperature and lowering the temperature of the mold, which permits rapid subsequent press-bonding operation of the wheel plate assembly, thereby significantly enhancing the press-bonding efficiency of the composite material.

In an example, the wheel plate assembly further comprises a nozzle unit and at least one air bag. The nozzle unit includes a gas inlet and at least one gas outlet intercommunicating with the gas inlet. All or a portion of the nozzle unit is installed in the receiving space. The gas inlet is exposed to an environment. The at least one gas outlet is aligned with the at least one passage space. The at least one air bag is disposed in the inner space and defines an air bag space. The air bag includes an inlet end and a main extension section. The inlet end is an opening connected to the at least one gas outlet, such that the at least one gas outlet intercommunicates with the air bag space via the inlet end. When a gas is inputted via the gas inlet, the gas passes through the at least one gas outlet and enters the air bag space, such that the main extension section of the air bag expands to support the spoke portion. Therefore, by application of the nozzle and the air bag, the supporting force/pressure-bearing capacity of the spoke portion can be reinforced.

In an example, the wheel plate assembly further includes a first positioning portion. The nozzle unit further includes a second positioning portion. The first positioning portion and the second positioning portion engage with each other. Therefore, by the engagement between the second positioning portion and the first positioning portion, the mounting stability of the nozzle unit and the wheel plate assembly can be enhanced.

In an example, all or a portion of the spoke portion exposed to the environment is coated by a composite material. Therefore, the strength of the spoke portion can be enhanced by coating the spoke portion with the composite material.

In an example, the wheel plate body includes at least one mounting hole. The composite material is filled into the wheel plate body via the at least one mounting hole and is fixed. Therefore, the stability of bonding the composite material to the wheel plate assembly can be enhanced by mounting the composite material in the installation hole.

In an example, one of the spoke portion and the connecting member includes an engaging groove. Another of the spoke portion and the connecting member includes an engaging protrusion. The engaging groove and the engaging protrusion have complementary shapes, such that the spoke portion and the connecting member are engaged via the engaging groove and the engaging protrusion. Therefore, the engagement stability between the spoke portion and the connecting member can be enhanced by the engaging groove and the engaging protrusion.

In an example, the spoke portion includes an upper-half casing and a lower-half casing coupled with the upper-half casing. The upper-half casing includes a first through-hole extending in an axial direction. The upper-half casing further includes a plurality of first extension portions each extending outward in a radial direction perpendicular to the axial direction. At least one of the upper-half casing and the lower-half casing includes an inner side which is recessed to form the inner space. The first through-hole intercommunicates with the inner space. The lower-half casing includes a plurality of second extension portions each extending outward in a radial direction and corresponding to an associated first extension portion. Therefore, by the structural disposition of the upper-half shell and the lower-half shell to form the spoke portion and the inner space, the spoke portion is easy to produce and assemble.

In an example, the wheel plate body is placed into the first through-hole to couple with the spoke portion. The wheel plate body includes an upper-half wheel plate and a lower-half wheel plate. The upper-half wheel plate includes at least one through-hole and at least one first extension groove. The lower-half wheel plate includes a recessed portion and at least one second extension groove. The through-hole and the recessed portion are aligned with each other and together form the receiving space. The at least one first extension groove and the at least one second extension groove are aligned with each other and together form the at least one passage space. Therefore, by the structural disposition of the upper-half wheel plate and the lower-half wheel plate to form the receiving space and the passage space, the wheel plate assembly permits easy press-bonding of the composite material.

In an example, during the press-bonding process, the upper mold and the lower mold press-bond the wheel plate assembly to a preset pressure, and then the gas is inputted via the gas input portion into the gas inlet to expand the air bag to a second preset pressure. The temperature of the mold is increased during the press-bonding process, such that the composite material is heated and hardens. Therefore, by the provision of the first preset pressure and the second preset pressure and by heating the composite material, the stability of press-bonding the composite material to the wheel plate assembly can be enhanced.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a diagrammatic exploded, perspective view of a wheel plate assembly of a preferred embodiment according to the present invention.

FIG. 2 is a diagrammatic cross sectional view of the wheel plate assembly of an embodiment according to the present invention after assembly.

FIG. 3 is an exploded, perspective view of an example of a nozzle unit according to the present invention.

FIG. 4 is a perspective view illustrating the wheel plate assembly of an embodiment according to the present invention after assembly.

FIG. 5 is a cross sectional view taken along section line 5-5 of FIG. 4.

FIG. 6 is a perspective view illustrating a composite material bonded to the assembly structure of FIG. 4.

FIG. 7 is a diagrammatic cross sectional view taken along section line 7-7 of FIG. 6, illustrating press-bonding of the composite material by a mold.

FIG. 8 is a diagrammatic cross sectional view similar to FIG. 7, illustrating press-bonding by the mold.

FIG. 9 is a diagrammatic perspective view illustrating the wheel plate assembly including the composite material according to the present invention assembled with a wheel frame.

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

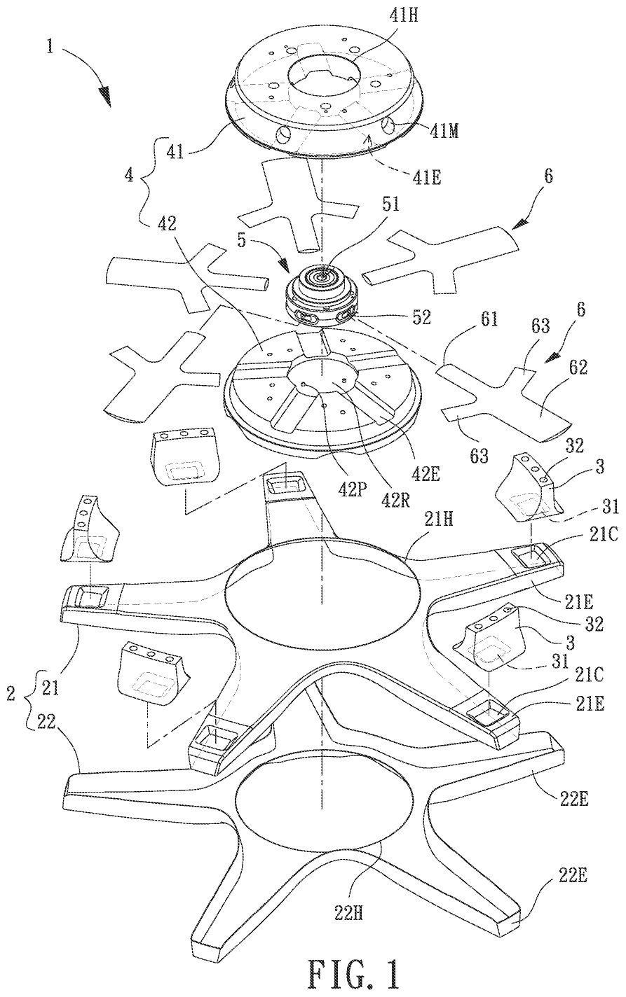

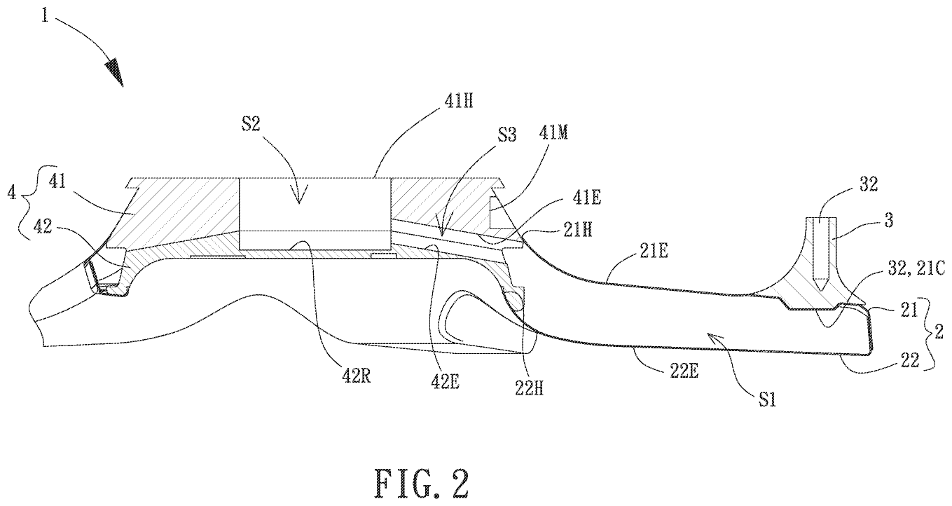

With reference to FIGS. 1 and 2, a wheel plate assembly of a preferred embodiment according to the present invention comprises a spoke portion 2, at least one connecting member 3, and a wheel plate body 4. The at least one connecting member 3 is connected to the wheel plate body 4 and the spoke portion 2.

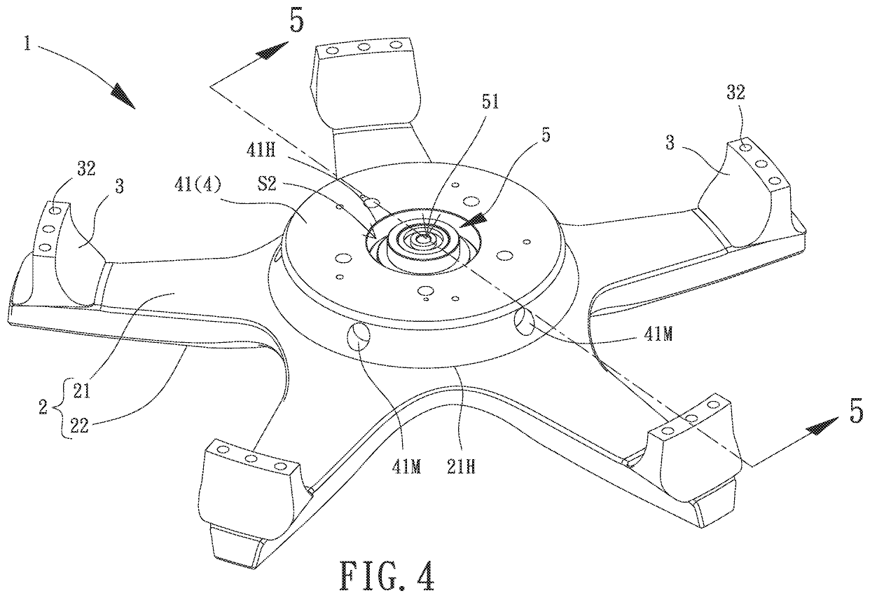

The spoke portion 2 is a thin shell member and defines an inner space S1 therein (see FIG. 4). Specifically, in an embodiment, the spoke portion 2 may include an upper-half casing 21 and a lower-half casing 22. The upper-half casing 21 includes a first through-hole 21H extending in an axial direction. The upper-half casing 21 further includes a plurality of first extension portions 21E each extending outward in a radial direction perpendicular to the axial direction. The upper-half casing 21 includes a plurality of first engaging portions 21C on an outer surface thereof opposite to the inner space S1. In an embodiment, each first engaging portion 21C is recessed in the outer surface of the upper-half casing 21 to form an engaging groove and is preferably disposed in a location adjacent to a distal end of an associated first extension portion 21E. In an embodiment, the upper-half casing 21 may be a thin shell member and includes an outer wall portion extending in the axial direction (such as the downwardly extending outer wall portion shown in FIG. 1).

The lower-half casing 22 is coupled with the upper-half casing 21 to define the inner space S1. Specifically, at least one of the upper-half casing 21 and the lower-half casing 22 includes an inner side which is recessed, such that when the lower-half casing 22 is coupled with the upper-half casing 21, the recession forms the inner space S1. The first through-hole 21H intercommunicates with the inner space S1. The lower-half casing 22 includes a plurality of second extension portions 22E each extending outward in a radial direction and corresponding to an associated first extension portion 21E (one to one correspondence). In an embodiment, the lower-half casing 22 may be a thin shell member and includes an outer wall portion extending in the axial direction (such as the downwardly extending outer wall portion shown in FIG. 1) for coupling with the thin-shell upper-half casing 21. In an embodiment, the lower-half casing 22 may include a second through-hole 22H aligned with the first through-hole 21H. The second through-hole 22H intercommunicates with the inner space S1.

Optionally, the thickness of each of the thin shell members formed by the spoke portion 2, the upper-half casing 21, and the lower-half casing 22 is 0.2-1 mm. Preferably, the thickness of the thin shell members is 0.5 mm. By selecting the thickness of the thin shell members, the material used can be effectively reduced. Optionally, the material of the thin shell members may be polyvinyl chloride (PVC) or acrylonitrile butadiene styrene (ABS).

It should be noted that according to the drawings of the present invention, the number of each of the first extension portions 21E and the second extension portions 22E is five. However, the number of the extensions 21E, 22E is not limited in the present invention.

The at least one connecting member 3 is protrusively disposed on an outer side of the spoke portion 2. In an embodiment, each connecting member 3 may include a second engaging portion 31 for coupling with a corresponding first engaging portion 21C. Specifically, the second coupling portion 31 has a shape complementary to the shape of the first engaging portion 21C to reinforce the coupling stability between the first engaging portion 21C and the second engaging portion 31. In an embodiment, the first engaging portions 21C is recessed in the outer surface of the upper-half casing 21 to form an engaging groove, and the second engaging portion 31 protrudes from a lower side of the connecting member 3 to form an engaging protrusion. Namely, one of the spoke portion 2 and the connecting member 3 includes an engaging groove, and another of the spoke portion 2 and the connecting member 3 includes an engaging protrusion. The engaging groove and the engaging protrusion match with each other in shape to engage the spoke portion 2 with the connecting member 3. In other words, the engaging groove and the engaging protrusion have complementary shapes, such that the spoke portion 2 and the connecting member 3 are engaged via the engaging groove and the engaging protrusion. In an embodiment, the connecting member 3 may include at least one connecting hole 32. Optionally the connecting member 3 may be made of aluminum.

The wheel plate body 4 includes a receiving space S2 and at least one passage space S3 intercommunicating with the receiving space S2 (see FIG. 2). The receiving space S2 and the at least one passage space S3 together extend through the wheel plate body 4. The at least one passage space S3 intercommunicates with the inner space S1. In an embodiment, the receiving space S2 may extend in the axial direction, and the passage space S3 may extend in a radial direction. Specifically, in an embodiment, the wheel plate body 4 can be placed into the first through-hole 21H to couple with the spoke portion 2. In an embodiment, the wheel plate body 4 may include an upper-half wheel plate 41 and a lower-half wheel plate 42. The upper-half wheel plate 41 may include at least one through-hole 41H and at least one first extension groove 41E. In an embodiment, the upper-half wheel plate 41 may include at least one mounting hole 41M. Preferably, each mounting hole 41M is disposed corresponding to an associated first extension portion 21E. The lower-half wheel plate 42 may include a recessed portion 42R and at least one second extension groove 42E. The through-hole 41H and the recessed portion 42R may be aligned with each other and together form the receiving space S2. The at least one first extension groove 41E and the at least one second extension groove 42E may be aligned with each other and together form the passage space S3. In an embodiment, the lower-half wheel plate 42 may include a first positioning portion 42P.

It should be noted that the structural features and disposition of the above upper-half casing 21 and the above lower-half casing 22 are merely a workable implementation example embodying the spoke portion 2 of the present invention. Furthermore, in the present invention, the main feature of the spoke portion 2 is to provide a thin shell member having the inner space S1 and an optional first through-hole 21H for mounting the wheel plate body 4 while optionally including the first engaging portion 21C for mounting the connecting member 3.

Please refer to FIGS. 1-3 and 5 which show an example of disposition of a nozzle unit 5 and at least one air bag 6 into the above wheel plate assembly 1 according to the present invention. The he nozzle unit 5 includes a gas inlet 51 and at least one gas outlet 52 intercommunicating with the gas inlet 51. All or a portion of the nozzle unit 5 is installed in the receiving space S2. The gas inlet 51 is exposed to the environment. The at least one gas outlet 52 is aligned with the at least one passage space S3. In an embodiment, the nozzle unit 5 may include a second positioning portion 5P, such that when the nozzle unit 5 is mounted in the receiving space S2, the second positioning portion 5P and the first positioning portion 42P engage with each other, thereby enhancing the engaging stability between the nozzle unit 5 and the wheel plate body 4, particularly avoiding relative rotational movement between the nozzle unit 5 and the wheel plate body 4.

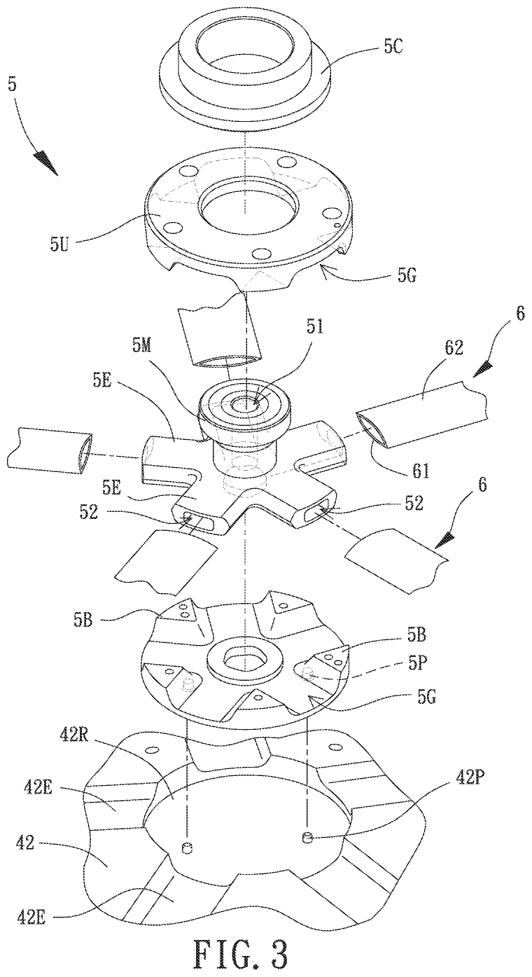

With reference to FIG. 3 showing an implantation example of the nozzle unit 5, the nozzle unit 5 includes a nozzle body 5M, a nozzle upper cover 5U, a nozzle base 5B, and an optional nozzle cap 5C. In an embodiment, the number of the at least one gas outlet 52 corresponds to the number of the at least one first extension portion 21E. The nozzle body 5M includes the gas inlet 51 and the at least one gas outlet 52. In an embodiment, the nozzle body 5M may include at least one nozzle extension 5E extending outward in a radial direction. Each nozzle extension 5E may include a corresponding one of the at least one gas outlet 52 (namely, a gas outlet 52 is disposed on each nozzle extension 5E). The nozzle upper cover 5U and the nozzle base 5B engage with each other to form a space for partially receiving the nozzle body 5M, such that the nozzle body 5M can be coupled between the nozzle upper cover 5U and the nozzle base 5B. Particularly, in a case that the nozzle body 5M includes the nozzle extension portion 5E, one or both of the nozzle upper cover 5U and the nozzle base 5B have a groove 5G corresponding to the nozzle extension portion 5E, such that when the nozzle upper cover 5U engages with the nozzle base 5B, all or a portion of the nozzle extension portion 5E is received in the space formed by the groove 5G, thereby protecting the gas outlet 52. The nozzle cap 5C is connected to the nozzle body 5M and the nozzle upper cover 5U. In an embodiment, the bottom of the nozzle base 5B may include the second positioning portion 5P. Specifically, the second positioning portion 5P has a shape complementary to the shape of the first positioning portion 42P to reinforce the coupling stability between the first positioning portion 42P and the second positioning portion 5P. Optionally, the first positioning portion 42P protrudes outward from an upper surface of the lower-half wheel plate 42 to form a positioning peg, and the second positioning portion 5P is recessed in a lower surface of the nozzle base 5B to form a positioning hole.

It should be noted that each element illustrated in FIG. 3 is merely a workable implementation example embodying the nozzle unit 5. Furthermore, the main feature of the nozzle unit 5 according to the present invention is to provide the gas inlet 51, the at least one gas outlet 52, and the optional second positioning portion 5P. Therefore, in other examples, each element may be integrally formed or have another disposition (such as including more or fewer elements or having different shapes) to include the gas inlet 51, the at least one gas outlet 52, and the optional second positioning portion 5P of the above nozzle unit 5

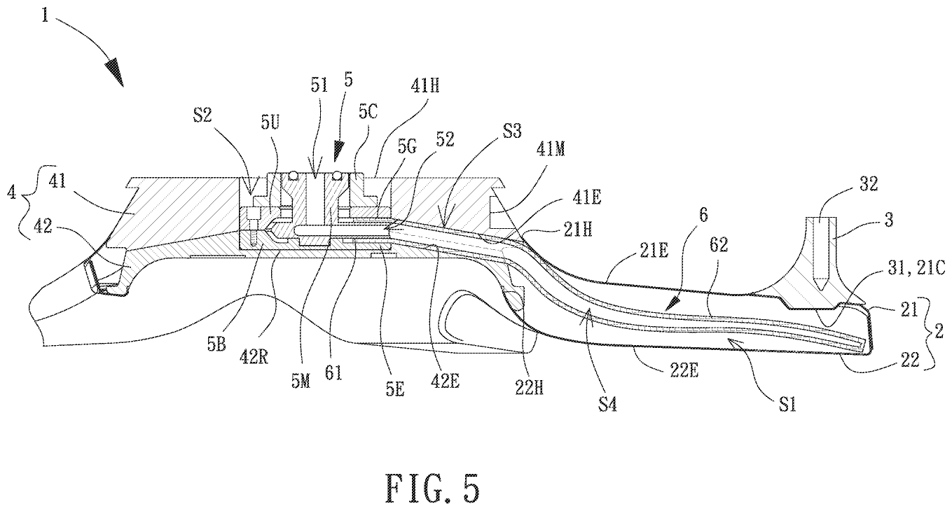

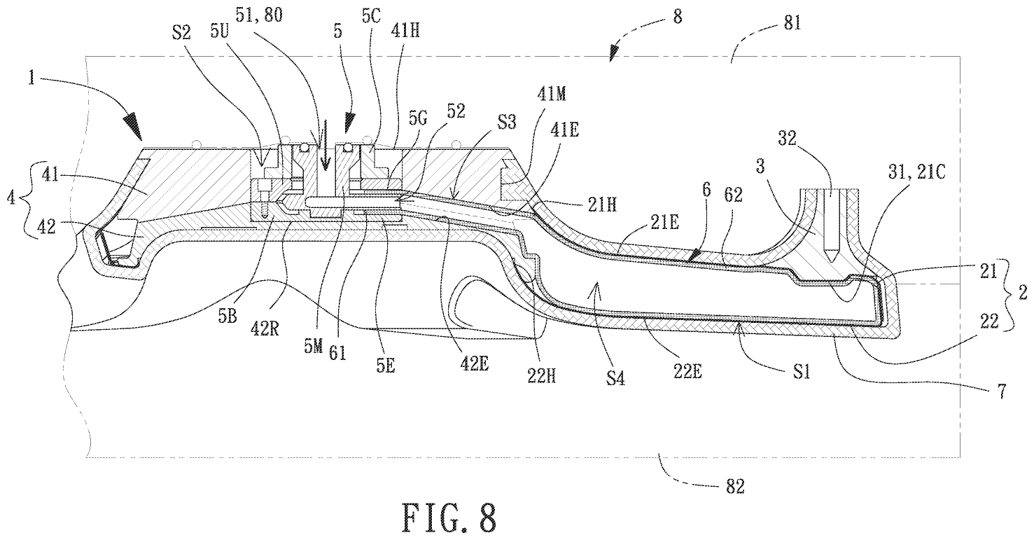

With reference to FIGS. 1, 3, and 5, the at least one air bag 6 is disposed in the inner space S1 and defines an air bag space S4 (FIG. 5). The air bag 6 includes an inlet end 61, a main extension section 62, and at least one optional branch section 63. The inlet end 61 is an opening connected to the at least one gas outlet 52 to intercommunicate the at least one gas outlet 52 with the air bag space S4, such that a gas may be inputted via the gas inlet 51 and pass through the gas outlet 52 to enter the air bag space S4. Thus, the main extension section 62 and/or the at least one branch section 63 of the air bag 6 expands to support the spoke portion 2 (see FIG. 8). Specifically, the main extension section 62 extends a distance in the radial direction from the inlet end 61 to correspond to an associated first extension portion 21E. Preferably, a distal end (away from the inlet end 61) of the main extension section 62 after expansion can abut against a distal end of the spoke portion 2 (such as the upper-half casing 21 or the lower-half casing 22) in the inner space S1 and can support the spoke portion 2. The branch sections 63 are located between the inlet end 61 and the distal end of the main extension section 62 and are substantially disposed in a circumferential direction (each branch section 63 extends in a radial direction) relative to the spoke portion 2 and the wheel plate body 4, such that the branch sections 63 can support a portion of the spoke portion 2 not supported by the main extension section 62 before the air bag 6 expands. In an embodiment, the inlet end 61 is fit in the nozzle extension portion 5E. Preferably, the space defined by the first extension portion 21E, the second extension portion 22E, the first extension groove 41E, and the second extension groove 42E is used to receive the main extension section 62.

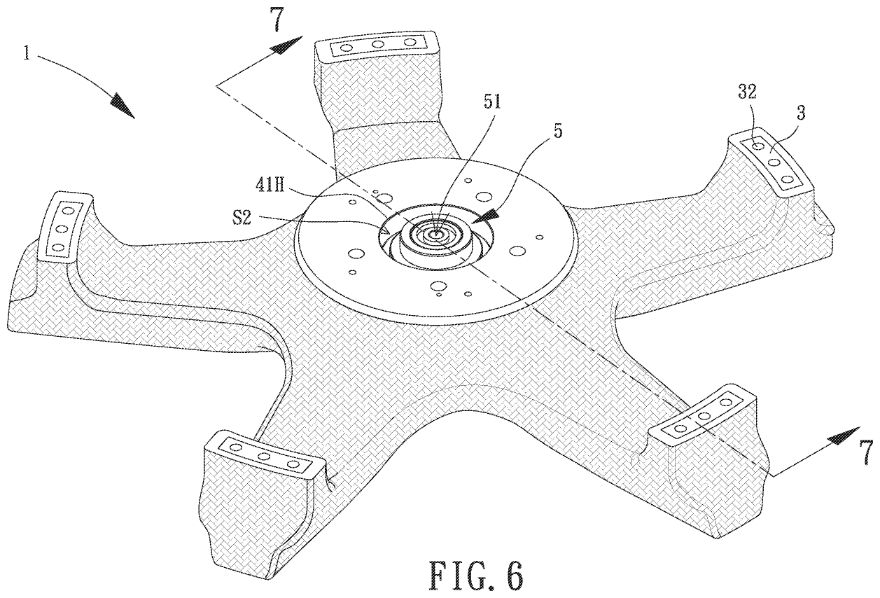

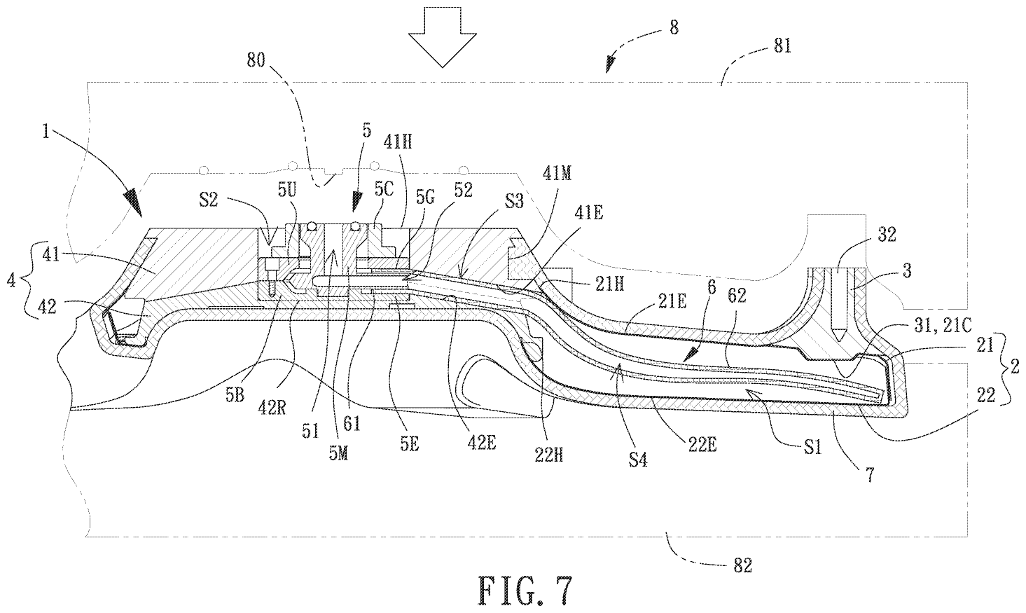

Please refer to FIG. 6 illustrating a composite material 7 adhered to the outer surface of the above wheel plate assembly 1. The composite material 7 may be in a condition of initially adhered to the spoke portion 2 or securely bonded to the spoke portion 2. As shown in FIG. 7, the mounting hole 41M of the upper-half wheel plate 41 may be used to permit insertion of the composite material 7, preferably by press-fit, thereby enhancing the bonding stability between the composite material 7 and the spoke portion 2.

Particularly, in a case that the composite material 7 is initially adhered to the spoke portion 2, the composite material 7 requires further heating and pressurization to securely bond the composite material 7 to the spoke portion 2. According to the structures and disposition of the above wheel plate assembly 1, the nozzle unit 5, and the at last one air bag 6, the present invention may perform a method for producing a spoke portion with a composite material. In an embodiment, the method includes steps S1, S2, S3.

In step S1, as shown in FIG. 6, the spoke portion 2 of the wheel plate assembly 1 coated by the composite material 7, particularly the portion of the spoke portion 2 exposed to the environment, and the connecting hole 32 is preferably exposed to the environment (namely, the connecting hole 32 is not shielded). Preferably, the composite material 7 is placed into the mounting hole 41M of the upper-half wheel plate 41 (see FIG. 7), such that the composite material 7 can more stably coat the spoke portion 2.

In step S2, as shown in FIG. 7, the wheel plate assembly 1 coated by the composite material 7 is placed into a mold 8. The mold 8 includes a gas input portion 80 and a press/bonding contour corresponding to the shape of the wheel plate assembly 1 coated by the composite material 7 (such as an upper mold 81 and a lower mold 82, with the upper and lower molds 81, 82 having upper and lower contours corresponding to a to-be-press/bonded area of an object), such that the composite material 7 can be securely bonded to the wheel plate assembly 1 (particularly the spoke portion 2) after the wheel plate assembly 1 coated by the composite material 7 is subjected to heating and press-bonding by the mold 8. Specifically, as shown in FIG. 8, when the mold 8 is press-bonding the wheel plate assembly 1, the gas input portion 80 is connected to the gas inlet 51 to input a gas into the gas inlet 51, such that the air bag 6 expands to provide a corresponding supporting force supporting the spoke portion 2 from an interior of the spoke portion 2. At this time, a side of the composite material 7 not bonded to the wheel plate assembly 1 is subjected to the pressing force from the mold 8, whereas another side of the composite material 7 bonded to the wheel plate assembly 1 is subjected to the supporting force from the air bag 6. The pressing force and the supporting force together press-bond the composite material 7 to more efficiently press-bond the composite material 7 to the spoke portion 2. Furthermore, during the press-bonding process of the mold 8, the above supporting force also reliably prevents deformation of the spoke portion 2 (particularly in the form of a shell member) under the above pressing force, thereby avoiding generation of gaps between the composite material 7 and the mold 8 or uneven force caused by the deformation. Thus, the overall press-bonding quality is enhanced.

In step S3, as shown in FIG. 8, the mold 8 is used to press-bond the composite material 7 to the wheel plate assembly 1. During the press-bonding process, the gas input portion 80 is connected to the gas inlet 51, and the gas is inputted via the gas input portion 80 into the gas inlet 51 to expand the air bag 6. Expansion of the air bag 6 generates an outward pushing force from the interior of the spoke portion 2 (pressing against the spoke portion 2 to generate the corresponding supporting force), thereby stably press-bonding the composite material 7 to the wheel plate assembly 1. Particularly, the upper mold 81 and the lower mold 82 firstly press-bond the wheel plate assembly 1 to a preset pressure, and then the gas is inputted via the gas input portion 80 into the gas inlet 51 to expand the air bag 6 to a second preset pressure. Preferably, the temperature of the mold 8 is increased during the press-bonding process, such that the composite material 7 is heated and, thus, can be more securely bonded to the wheel plate assembly 1. Particularly, the composite material 7 hardens when it is heated. Therefore, in a case of raising to a specific temperature during the press-bonding process to benefit the press-bonding of the composite material 7, the mold 8 may maintain the desired relatively high temperature required for press-bonding, such that it is not necessary to repeatedly increase the temperature of the mold 8 (for press-bonding the composite material to the mold onto the wheel plate assembly) and lowering the temperature of the mold 8 (for adhering the composite material onto the mold). Therefore, a next press-bonding operation can be rapidly proceeded after completing press-bonding of the composite material 7 to a set of wheel plate assembly 1, thereby significantly increasing the press-bonding efficiency of the composite material 7. It should be noted that increasing the temperature of the mold is a technique which can be appreciated and achieved by one having ordinary skill in the art and can be adjusted and applied in the present invention according to practical needs and is, thus, not described in detail to avoid redundancy. Particularly, the nozzle cap 5C abuts against the upper mold 81 during the press-bonding process of the mold 8 to apply a pressing force to the nozzle upper cover 5U and the nozzle base 5B, such that the nozzle upper cover 5U and the nozzle base 5B can tightly abut against each other for closing the inlet end 61 of the air bag 6, avoiding generation of gaps between the nozzle upper cover 5U and the nozzle base 5B under the action of expansion of the air bag 6, thereby maintaining a stable gas pressure in the air bag 6.

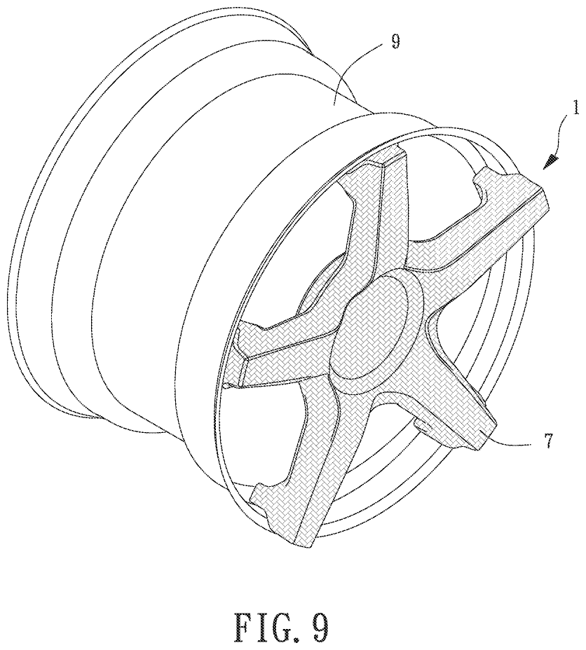

Please refer to FIG. 9 which is a diagrammatic view illustrating installation of the wheel plate assembly 1 (particularly, the nozzle unit 5 is removed from the wheel plate assembly 1) with the composite material 7 obtained from the above steps onto a wheel frame 9. The wheel frame 9 includes a predisposed installation portion (not shown), and the wheel plate assembly 1 can be mounted to the installation portion via the connecting hole 32 (see FIG. 6), thereby forming a wheel frame assembly.

It should be noted that the description and the implementation examples of the present invention are based on the portion of the composite material 7 coated on the spoke portion 2 which is exposed to the environment. Nevertheless, based on the overall structure of the above wheel plate assembly 1 and the corresponding producing method, in other implementation examples (in which the composite material 7 is in an initial bonding state and a stable adhered state), the spoke portion 2 and/or the wheel plate body 4 which are/is partially or completely exposed to the environment can be coated by the composite material 7.

In view of the foregoing, in the wheel plate assembly according to the present invention, by the structure formed of the spoke portion and the wheel plate body which define the inner space, the receiving space, the passage space which intercommunicate with each other, the composite material can be advantageously pre-adhered to the wheel plate assembly, which benefits the process of press-bonding the composite material to the wheel plate assembly. Furthermore, by application of the nozzle unit and the air bag, during the process of press-bonding the composite material to the wheel plate assembly, a supporting/pushing force can be provided from the interior of the air bag to reinforce the pressure-bearing capacity of the whole wheel plate assembly while enhancing the efficiency and quality of press-bonding of the composite material. Furthermore, by providing the wheel plate body with the mounting hole for insertion of the composite material, the stability of bonding the composite material to the wheel plate assembly can be enhanced. Furthermore, by the overall structure and mechanism of the wheel plate assembly, the mold can maintain the relative high temperature required for press-bonding, such that it is not necessary to repeat the operation of increasing the temperature and lowering the temperature of the mold, which permits rapid subsequent press-bonding operation of the wheel plate assembly, thereby significantly enhancing the press-bonding efficiency of the composite material.

Although the invention has been described in detail with reference to its presently preferable embodiments, it will be understood by one of ordinary skill in the art that various modifications can be made without departing from the spirit and the scope of the invention, as set forth in the appended claims. Further, if the above-mentioned several embodiments can be combined, the present invention includes any implementation aspects of combinations thereof

What is claimed is:

1. A wheel plate assembly comprising:
a spoke portion which is a thin shell member and which defines an inner space therein;
a connecting member protrusively disposed on an outer side of the spoke portion; and
a wheel plate body including a receiving space and at least one passage space intercommunicating with the receiving space, wherein the receiving space and the at least one passage space together extend through the wheel plate body, and wherein the at least one passage space intercommunicates with the inner space.

2. The wheel plate assembly as claimed in claim 1, further comprising a nozzle unit and at least one air bag, wherein the nozzle unit includes a gas inlet and at least one gas outlet intercommunicating with the gas inlet, wherein all or a portion of the nozzle unit is installed in the receiving space, wherein the gas inlet is exposed to an environment, wherein the at least one gas outlet is aligned with the at least one passage space, wherein the at least one air bag is disposed in the inner space and defines an air bag space, wherein the air bag includes an inlet end and a main extension section, wherein the inlet end is an opening connected to the at least one gas outlet, such that the at least one gas outlet intercommunicates with the air bag space via the inlet end, and wherein when a gas is inputted via the gas inlet, the gas passes through the at least one gas outlet and enters the air bag space, such that the main extension section of the air bag expands to support the spoke portion.

3. The wheel plate assembly as claimed in claim 2, wherein the wheel plate assembly further includes a first positioning portion, wherein the nozzle unit further includes a second positioning portion, and wherein the first positioning portion and the second positioning portion engage with each other.

4. The wheel plate assembly as claimed in claim 1, wherein all or a portion of the spoke portion exposed to the environment is coated by a composite material.

5. The wheel plate assembly as claimed in claim 4, wherein the wheel plate body includes at least one mounting hole, and wherein the composite material is filled into the wheel plate body via the at least one mounting hole and is fixed.

6. The wheel plate assembly as claimed in claim 1, wherein one of the spoke portion and the connecting member includes an engaging groove, wherein another of the spoke portion and the connecting member includes an engaging protrusion, and wherein the engaging groove and the engaging protrusion have complementary shapes, such that the spoke portion and the connecting member are engaged via the engaging groove and the engaging protrusion.

7. The wheel plate assembly as claimed in claim 1, wherein the spoke portion includes an upper-half casing and a lower-half casing coupled with the upper-half casing, wherein the upper-half casing includes a first through-hole extending in an axial direction, wherein the upper-half casing further includes a plurality of first extension portions each extending outward in a radial direction perpendicular to the axial direction, wherein at least one of the upper-half casing and the lower-half casing includes an inner side which is recessed to form the inner space, wherein the first through-hole intercommunicates with the inner space, and wherein the lower-half casing includes a plurality of second extension portions each extending outward in a radial direction and corresponding to an associated first extension portion.

8. The wheel plate assembly as claimed in claim 7, wherein the wheel plate body is placed into the first through-hole to couple with the spoke portion, wherein the wheel plate body includes an upper-half wheel plate and a lower-half wheel plate, wherein the upper-half wheel plate includes at least one through-hole and at least one first extension groove, wherein the lower-half wheel plate includes a recessed portion and at least one second extension groove, wherein the through-hole and the recessed portion are aligned with each other and together form the receiving space, and wherein the at least one first extension groove and the at least one second extension groove are aligned with each other and together form the at least one passage space.

9. A method for producing a wheel plate assembly including a composite material as claimed in claim 2, the method comprising:
coating the spoke portion of the wheel plate assembly with the composite material;
placing the wheel plate assembly coated by the composite material into a mold, wherein the mold includes a gas input portion, an upper mold, and a lower mold, and wherein the upper mold and the lower mold have press-bonding contours corresponding to a shape of the wheel plate assembly coated by the composite material; and
using the mold to press-bond the composite material onto the wheel plate assembly, and during the press-bonding process, the gas input portion is connected to the gas inlet, wherein a gas is inputted via the gas input portion into the gas inlet to expand the air bag, and wherein expansion of the air bag generates an outward pushing force from an interior of the spoke portion, thereby stably press-bonding the composite material to the wheel plate assembly.

10. The method for producing the wheel plate assembly including the composite material as claimed in claim 9, wherein during the press-bonding process, the upper mold and the lower mold press-bond the wheel plate assembly to a preset pressure, and then the gas is inputted via the gas input portion into the gas inlet to expand the air bag to a second preset pressure, wherein a temperature of the mold is increased during the press-bonding process, such that the composite material is heated and hardens.

11. A method for producing a wheel plate assembly including a composite material as claimed in claim 3, the method comprising:
coating the spoke portion of the wheel plate assembly with the composite material;
placing the wheel plate assembly coated by the composite material into a mold, wherein the mold includes a gas input portion, an upper mold, and a lower mold, and wherein the upper mold and the lower mold have press-bonding contours corresponding to a shape of the wheel plate assembly coated by the composite material; and
using the mold to press-bond the composite material onto the wheel plate assembly, and during the press-bonding process, the gas input portion is connected to the gas inlet, wherein a gas is inputted via the gas input portion into the gas inlet to expand the air bag, and wherein expansion of the air bag generates an outward pushing force from an interior of the spoke portion, thereby stably press-bonding the composite material to the wheel plate assembly.

12. The method for producing the wheel plate assembly including the composite material as claimed in claim 11, wherein during the press-bonding process, the upper mold and the lower mold press-bond the wheel plate assembly to a preset pressure, and then the gas is inputted via the gas input portion into the gas inlet to expand the air bag to a second preset pressure, wherein a temperature of the mold is increased during the press-bonding process, such that the composite material is heated and hardens.
